(19) United States
(12) Patent Application Publication
(10) Pub. No.: US 2021/0192956 A1
(43) Pub. Date: Jun. 24, 2021

(54) VEHICLE CONTROL SYSTEM, VEHICLE CONTROL METHOD, AND VEHICLE CONTROL PROGRAM

(71) Applicant: HONDA MOTOR CO., LTD., Minato-ku Tokyo (JP)

(72) Inventor: Masanori Takeda, Wako-shi (JP)

(21) Appl. No.: 16/081,460

(22) PCT Filed: Mar. 8, 2017
(86) PCT No.: PCT/JP2017/009225

§ 371 Date: Aug. 31, 2018

(30) Foreign Application Priority Data
Mar. 15, 2016 (JP) 2016-050734

(51) Int. Cl. G08G 1/00; G08G 1/01; G01C 21/36

(52) U.S. Cl. CPC G08G 1/20; G08G 1/0125; G01C 21/3605; G08G 1/0141; G08G 1/0145

(57) ABSTRACT

A vehicle control system includes an acquisition unit that acquires traffic condition information of a main line, a first controller that determines whether the host vehicle is able to join the main line on the basis of the traffic condition information acquired by the acquisition unit and a length of a mergeable section in a merging place from the branch line to the main line, and a second controller that automatically controls at least acceleration and deceleration of the host vehicle such that the host vehicle travels from the branch line toward the main line in a case it is determined by the first controller that the host vehicle is able to join the main line.

### TECHNICAL FIELD

The present invention relates to a vehicle control system, a vehicle control method, and a vehicle control program.

Priority is claimed on Japanese Patent Application No. 2016-050734, filed Mar. 15, 2016, the content of which is incorporated herein by reference.

### BACKGROUND ART

In recent years, research has been performed on a technology (hereinafter, automated driving) of automatically controlling at least one of acceleration, deceleration and steering of a host vehicle such that the host vehicle travels along a route to a destination. In this regard, various technologies have also been disclosed in automated driving when a vehicle joins a main line from a branch line of an expressway or the like (for example, see Patent Literature 1).

### CITATION LIST

### Patent Literature

### [Patent Literature 1]

Japanese Unexamined Patent Application, First Publication No. 2015-102893

### SUMMARY OF INVENTION

### Technical Problem

However, in the technology of the related art, there was a case in which a timing of determination of whether merging from a branch line to a main line is possible is late.

An aspect of the present invention is directed to providing a vehicle control system, a vehicle control method, and a vehicle control program, in which determination of whether merging is possible can be rapidly performed.

### Solution to Problem

(1) A vehicle control system according to an aspect of the present invention includes an acquisition unit that acquires traffic condition information of a main line to which a host vehicle is going to join from a branch line; a first controller that determines whether the host vehicle is able to join the main line on the basis of the traffic condition information acquired by the acquisition unit and a length of a mergeable section in a merging place from the branch line to the main line; and a second controller that automatically controls at least acceleration and deceleration of the host vehicle such that the host vehicle travels from the branch line toward the main line in a case it is determined by the first controller that the host vehicle is able to join the main line.

(2) In the aspect of (1), by referring to a correspondence information in which both of the information obtained from the traffic condition information and the length of the mergeable section are made to respectively correspond with a success probability of merging from the branch line to the main line, the first controller may derive the success probability corresponding to the traffic condition information acquired by the acquisition unit, and may determine whether the host vehicle is able to join the main line on the basis of the derived success probability.

(3) In the aspect of (3), the success probability of merging may be a probability on the basis of a ratio between the length of the mergeable section and a traveling distance which the host vehicle travels from the branch line to the main line.

(4) In the aspect of (2) or (3), in the correspondence information, a speed of the host vehicle may be further made to correspond with the success probability, and by obtaining the speed of the host vehicle and by referring to the correspondence information by using the acquired speed of the host vehicle, the first controller may derive the success probability and determine whether the host vehicle is able to join the main line on the basis of the derived success probability.

(5) In the aspect of any one of (1) to (4), the vehicle control system may further include a switching controller that restricts a control of the second controller in a merging in a case it is determined by the first controller that the host vehicle is not able to join the main line.

(6) In the aspect of any one of (1) to (5), the traffic condition information may include an average speed of traveling vehicles on the main line and information from which an inter-vehicle distance of the traveling vehicles is able to be derived.

(7) A vehicle control system according to another aspect of the present invention includes an acquisition unit that acquires traffic condition information of a main line to which a host vehicle is going to join from a branch line; and a derivation part that derives a traveling distance corresponding to the traffic condition information acquired by the acquisition unit by referring to correspondence information in which information obtained from the traffic condition information and information of a traveling distance, which relates to a distance in which the vehicle travels in order to join to the main line, correspond to each other, and that derives a length of a mergeable section required for the host vehicle to join the main line on the basis of the derived traveling distance.

(8) In the aspect of (7), the correspondence information may be information in which information obtained from the traffic condition information and information of the traveling distance correspond to each other, and by referring to the correspondence information, the derivation part may derive the traveling distance corresponding to the speed of the host vehicle and the traffic condition information acquired by the acquisition unit.

(9) A method installed on a computer configured to control a vehicle according to an aspect of the present invention includes acquiring traffic condition information of a main line to which a host vehicle is going to join from a branch line; determining whether the host vehicle is able to join the main line on the basis of the acquired traffic condition information and a length of a mergeable section in which the host vehicle is able to join the main line from the branch line; and automatically controlling at least acceleration and deceleration of the host vehicle such that the host vehicle travels from the branch line toward the main line in a case it is determined that the host vehicle is able to join the main line.

(10) A vehicle control program according to an aspect of the present invention is installed in an in-vehicle computer and configured to perform: acquiring traffic condition information of a main line to which a host vehicle is going to join from a branch line; determining whether the host vehicle is able to join the main line on the basis of the acquired traffic condition information and a length of a mergeable section in which the host vehicle is able to join the main line from the branch line; and automatically controlling at least acceleration and deceleration of the host vehicle such that the host vehicle travels from the branch line toward the main line in a case it is determined that the host vehicle is able to join the main line.

### Advantageous Effects of Invention

According to the aspects of (1) to (10), determination of whether merging is possible can be rapidly performed.

### BRIEF DESCRIPTION OF DRAWINGS

FIG. 1 is a figure showing components of a host vehicle.

FIG. 2 is a functional configuration figure of the host vehicle.

FIG. 3 is a figure showing a state in which a relative position of the host vehicle with respect to a target lane is recognized by a host vehicle position recognition part.

FIG. 4 is a figure showing an example of an action plan generated in a certain section.

FIG. 5 is a figure showing an example of a configuration of a trajectory generating part.

FIG. 6 is a figure showing an example of trajectory candidates generated by a trajectory candidate generating part.

FIG. 7 is a flowchart showing an example of a flow of processing performed when a lane change event is performed.

FIG. 8 is a figure showing an aspect in which a lane change target area is set.

FIG. 9 is a figure showing an aspect in which a trajectory for lane change is generated.

FIG. 10 is a figure exemplarily showing merging target area candidates set by a merging target area candidate setting part.

FIG. 11 is a figure showing another example of merging target area candidates set by the merging target area candidate setting part.

FIG. 12 is a flowchart showing an example of a flow of processing of a merging controller according to a first embodiment.

FIG. 13 is a figure showing an example of correspondence information according to the first embodiment.

FIG. 14 is a figure showing an example of a certain map in the correspondence information of the first embodiment.

FIG. 15 is a figure showing a state of a variation in success probability on line 15-15′ in FIG. 14.

FIG. 16 is a figure for explaining an initial position displacement.

FIG. 17 is a figure for explaining an initial position displacement.

FIG. 18 is a figure showing an example of a speed of a host vehicle that satisfies a condition.

FIG. 19 is a figure for explaining processing by a derivation part.

FIG. 20 is a figure showing an example of correspondence information according to a second embodiment.

FIG. 21 is a figure showing an example of a certain map in the correspondence information of the second embodiment.

FIG. 22 is a figure showing an example of a relation between success probability of merging and a speed of a host vehicle.

### DESCRIPTION OF EMBODIMENTS

Hereinafter, embodiments of a vehicle control system, a vehicle control method, and a vehicle control program of the present invention will be described with reference to the accompanying drawings.

### Common Configuration

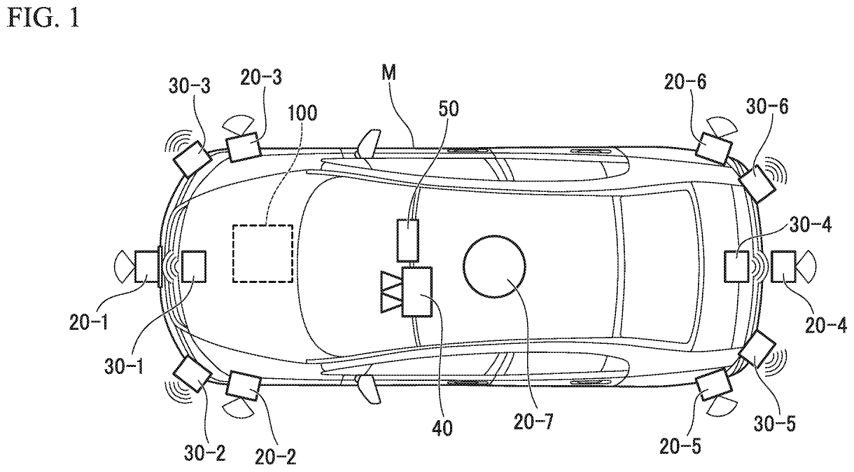

FIG. 1 is a figure showing components of a vehicle on which a vehicle control system 100 of an embodiment is mounted (hereinafter, referred to as a host vehicle M). The vehicle on which the vehicle control system 100 is mounted is an automobile such as a two-wheeled, three-wheeled, or four-wheeled vehicle, or the like, and includes an automobile using an internal combustion engine such as a diesel engine, a gasoline engine, or the like, as a power source, an electric automobile using an electric motor as a power source, a hybrid automobile including both of an internal combustion engine and an electric motor, and so on. The electric automobile is driven using electric power discharged by a battery such as a secondary battery, a hydrogen fuel cell, a metal fuel cell, an alcohol fuel cell, or the like.

As shown in FIG. 1, sensors such as finders 20-1 to 20-7, radars 30-1 to 30-6, a camera 40, and so on, a navigation device 50, and the vehicle control system 100 are mounted on the host vehicle M.

The finders 20-1 to 20-7 use, for example, light detection and ranging or laser imaging detection and ranging (LIDAR) configured to measure scattered radiation with respect to radiated light and measure a distance to an object. For example, the finder 20-1 is attached to a front grille or the like, and the finders 20-2 and 20-3 are attached to side surfaces of a vehicle body, door mirrors, the insides of headlights, the vicinity of side lights, or the like. The finder 20-4 is attached to a trunk lid or the like, and the finders 20-5 and 20-6 are attached to side surfaces of the vehicle body, insides of tail lamps, or the like. The above-mentioned finders 20-1 to 20-6 have, for example, detection regions of about 150 degrees in a horizontal direction. In addition, the finder 20-7 is attached to a roof or the like.

The finder 20-7 has, for example, a detection region of 360 degrees in the horizontal direction.

The radars 30-1 and 30-4 are, for example, long-distance millimeter wave radars having a detection region in a depth direction that is wider than that of other radars. In addition, the radars 30-2, 30-3, 30-5 and 30-6 are middle-range millimeter wave radars having a detection region in the depth direction that is narrower than that of the radars 30-1 and 30-4.

Hereinafter, when the finders 20-1 to 20-7 are not distinguished from each other, they are simply referred to as “finders 20,” and when the radars 30-1 to 30-6 are not distinguished from each other, they are simply referred to as “radars 30.” The radar 30 detects an object using, for example, a frequency modulated continuous wave (FM-CW) method.

The camera 40 is a digital camera using a solid imaging element such as a charge coupled device (CCD), a complementary metal oxide semiconductor (CMOS), or the like. The camera 40 is attached to an upper section of a front windshield, a back surface of a rear-view mirror, or the like. For example, the camera 40 periodically repeatedly images a side in front of the host vehicle M. The camera 40 may be a stereo camera including a plurality of cameras.

Further, the configuration shown in FIG. 1 is merely an example, and a part of the configuration may be omitted, or other components may be added.

### First Embodiment

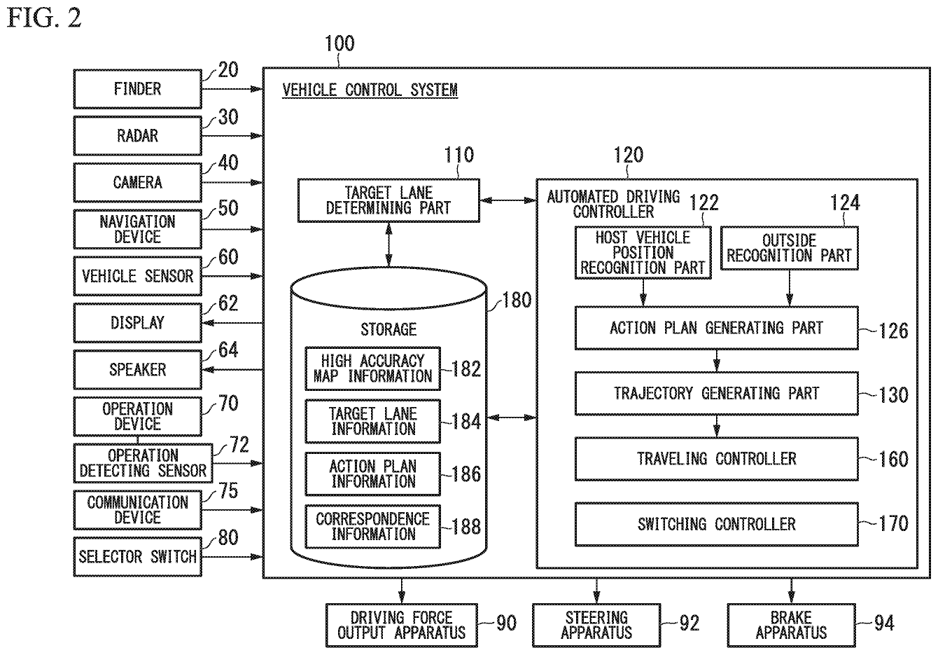

FIG. 2 is a functional configuration figure of the host vehicle M on which the vehicle control system 100 according to a first embodiment is mounted.

In addition to the finders 20, the radars 30 and the camera 40, the navigation device 50, a vehicle sensor 60, a display 62, a speaker 64, an operation device (a manipulator) 70 such as an accelerator pedal, a brake pedal, a shift lever (or a paddle shift), a steering wheel, or the like, an operation detecting sensor 72 such as an accelerator opening sensor, a brake pedaling amount sensor (a brake switch), a shift position sensor, a steering angle sensor (or a steering torque sensor), or the like, a communication device 75, a selector switch 80, a driving force output apparatus 90 configured to output a driving force for traveling, a steering apparatus 92, a brake apparatus 94, and the vehicle control system 100 are mounted on the host vehicle M.

These devices or instruments are connected to each other by a multiplex communication line such as a controller area network (CAN) communication line or the like, a serial communication line, a wireless communication network, or the like. The exemplified operation device is merely an example, a joystick, a button, a dial switch, a graphical user interface (GUI) switch, or the like, may be mounted on the host vehicle M. Further, the vehicle control system in the claims may include not only the vehicle control system 100 but also a configuration other than the vehicle control system 100 (the finders 20 or the like) among the configurations shown in FIG. 2.

The navigation device 50 has a global navigation satellite system (GNSS) receiver, map information (navigation map), a touch panel type display device serving as a user interface, a speaker, a microphone, or the like. The navigation device 50 identifies a position of the host vehicle M using a GNSS receiver, and derives a route from a position thereof to a destination designated by a user.

The route derived by the navigation device 50 is provided to a target lane determining part 110 of the vehicle control system 100. A position of the host vehicle M may be identified or complemented by the inertial navigation system (INS) using the output of the vehicle sensors 60.

In addition, the navigation device 50 performs guidance for a route to a destination using speech or navigation display when the vehicle control system 100 operates in a manual driving mode.

Further, the configuration for identifying the position of the host vehicle M may be installed independently from the navigation device 50.

In addition, the navigation device 50 may be realized by a function of a terminal device such as a smartphone, a tablet terminal, or the like, owned by a user. In this case, transmission and reception of information through wireless or wired communication between the terminal device and the vehicle control system 100 are performed.

The vehicle sensor 60 includes a vehicle speed sensor configured to detect a vehicle speed, an acceleration sensor configured to detect an acceleration, a yaw rate sensor configured to detect an angular speed around a vertical axis, an azimuth sensor configured to detect a direction of the host vehicle M, and so on.

The display 62 displays information as an image. The display 62 includes, for example, a liquid crystal display (LCD), an organic electroluminescence (EL) display device, a head-up display, or the like. The display 62 may be a display included in the navigation device 50, or a display of an installment panel configured to display a state (a speed or the like) of the host vehicle M. The speaker 64 outputs information as speech.

The operation detecting sensor 72 detects an operation amount of the operation device 70. For example, the operation detecting sensor 72 outputs an accelerator opening degree, a brake pedaling amount, a shift position, a steering angle, a steering torque, or the like, as detection results, to the vehicle control system 100. Further, instead of this, the detection results of the operation detecting sensor 72 according to a driving mode may be directly output to the driving force output apparatus 90, the steering apparatus 92, or the brake apparatus 94.

The communication device 75 performs wireless communication using an inter-vehicle communication network or the like that uses a cellular communication network, a Wi-Fi network, dedicated short range communications (DSRC), and so on. The communication device 75 acquires information from an information providing server before the host vehicle M travels or during traveling by, for example, connecting the communication device 75 to the Internet via a radio base station. For example, the communication device 75 acquires traffic condition information from the information providing server that observes a traffic state of a road.

The traffic condition information includes information on lanes being blocked due to roadwork, traffic accidents, traffic congestion, or the like, or information related to a traffic volume of a road. The information related to the traffic volume of the road includes, for example, information such as the number of vehicles passing through a certain section per unit time, a density of vehicle per a unit section, a vehicle-to-vehicle gap time for each lane, an average speed of traveling vehicles per each lane, and so on.

The vehicle-to-vehicle gap time is, at a certain time, a time required for a reference position (for example, a center of gravity, a center of a rear wheel shaft, or the like) of a vehicle traveling at rear of a merging target area candidate cTAg(k), which will be described below, to arrive at a point where a reference position (for example, a center of gravity, a center of a rear wheel shaft, or the like) of a vehicle traveling in front of a merging target area candidate cTAg(k) was present. Hereinafter, reference character δ(k) is attached to the vehicle-to-vehicle gap time of each of the merging target area candidates cTAg(k) and will be described.

The selector switch 80 is a switch operated by an occupant in the vehicle. The selector switch 80 receives an operation of an occupant in the vehicle, generates a driving mode designating signal that designates a driving mode of the host vehicle M, and outputs the driving mode designating signal to a switching controller 170. The selector switch 80 may be either a graphical user interface (GUI) switch or a mechanical switch.

The driving force output apparatus 90 outputs a traveling driving force (torque) for driving the vehicle to a driving wheel. The driving force output apparatus 90 includes, for example, an engine, a gear box, and an engine electric control unit (ECU) configured to control the engine when the host vehicle M is an automobile using an internal combustion engine as a power source. In addition, when the host vehicle M is an electric automobile using an electric motor as a power source, the driving force output apparatus 90 includes a traveling motor and a motor ECU configured to control the traveling motor. In addition, when the host vehicle M is a hybrid automobile, the driving force output apparatus 90 includes an engine, a gear box, an engine ECU, a traveling motor and a motor ECU.

When the driving force output apparatus 90 includes only an engine, the engine ECU adjusts a throttle opening degree, a shift stage, or the like, of the engine according to the information input from a traveling controller 160, which will be described below.

When driving force output apparatus 90 includes only a traveling motor, the motor ECU adjusts a duty ratio of a PWM signal provided to the traveling motor according to the information input from the traveling controller 160.

When the driving force output apparatus 90 includes an engine and a traveling motor, both of the engine ECU and the motor ECU cooperate with each other to control the traveling driving force according to the information input from the traveling controller 160.

The steering apparatus 92 includes, for example, a steering ECU and an electric motor. The electric motor changes a direction of a steered wheel by applying a force to, for example, a rack and pinion mechanism.

The steering ECU changes the direction of the steered wheel by driving the electric motor according to the information input from the vehicle control system 100 or the information of the input steering angle or steering torque.

The brake apparatus 94 is an electric servo brake apparatus including, for example, a brake caliper, a cylinder configured to transmit a hydraulic pressure to the brake caliper, an electric motor configured to generate a hydraulic pressure in the cylinder, and a braking controller.

The braking controller of the electric servo brake apparatus controls the electric motor according to the information input from the traveling controller 160, and a brake torque according to a braking operation is output to the wheels.

The electric servo brake apparatus may include a mechanism configured to transmit a hydraulic pressure generated by an operation of a brake pedal to a cylinder via a master cylinder as a backup.

Further, the brake apparatus 94 is not limited to the above-mentioned electric servo brake apparatus and may be an electronically controlled hydraulic brake apparatus. The electronically controlled hydraulic brake apparatus controls an actuator according to the information input from the traveling controller 160, and transmits the hydraulic pressure of the master cylinder to the cylinder.

In addition, the brake apparatus 94 may include a regeneration brake using a traveling motor that may be included in the driving force output apparatus 90. The regeneration brake uses the electric power generated by the traveling motor that may be included in the driving force output apparatus 90.

### Vehicle Control System

Hereinafter, the vehicle control system 100 will be described. The vehicle control system 100 is realized by, for example, one or more processors or hardware having an equivalent function. The vehicle control system 100 may be a configuration in which a processor such as a central processing unit (CPU) or the like, a storage device, and an electronic control unit (ECU), a micro-processing unit (MPU), or the like, to which a communication interface is connected by an internal bus, are combined.

The vehicle control system 100 includes, for example, the target lane determining part 110, an automated driving controller 120 and a storage 180.

The automated driving controller 120 includes, for example, a host vehicle position recognition part 122, an outside recognition part 124, an action plan generating part 126, a trajectory generating part 130, the traveling controller 160 and the switching controller 170.

Some or all of parts of the target lane determining part 110 and the automated driving controller 120 are realized as a processor executes a program (software). In addition, some of all of them may be realized by hardware such as a large scale integration (LSI), an application specific integrated circuit (ASIC), or the like, or may be realized by combination of software and hardware.

The communication device 75 and the outside recognition part 124, which are described above, are an example of “an acquisition unit.”

For example, information such as high accuracy map information 182, target lane information 184, action plan information 186, correspondence information 188, and so on, are stored in the storage 180.

The storage 180 is realized by a read only memory (ROM), a random access memory (RAM), a hard disk drive (HDD), a flash memory, or the like. The program executed by the processor may be previously stored on the storage 180, or may be downloaded from an external device via in-vehicle Internet equipment or the like.

In addition, the program may be installed on the storage 180 when a portable recording medium on which the program is stored is mounted on a drive device (not shown).

In addition, the vehicle control system 100 may be constituted by a plurality of computer devices that are decentralized.

The target lane determining part 110 is realized by, for example, the MPU. The target lane determining part 110 divides a route provided from the navigation device 50 into a plurality of blocks (for example, divided by each 100 [m] in a vehicle advance direction), and determines a target lane at each block with reference to the high accuracy map information 182. For example, the target lane determining part 110 performs determination that the host vehicle is traveling on which number of lane from the left. The target lane determining part 110 determines a target lane such that the host vehicle M can travel along a reasonable traveling route for advancing to a lane branched off, for example, when a branching point, a merging point, or the like, is present in the route. The target lane determined by the target lane determining part 110 is stored in the storage 180 as the target lane information 184.

The high accuracy map information 182 is map information that is more accurate than that of a navigation map provided in the navigation device 50. The high accuracy map information 182 includes, for example, information on centers of lanes, information on boundaries of lanes, or the like.

In addition, the high accuracy map information 182 may include road information, address information (address/zip code), facility information, telephone number information, and so on. The road information includes information that represents a kind of road such as an expressway, a toll road, a national road or a prefectural road, and information such as the number of lanes of a road, a width of each lane, an inclination of a road, a position of a road (three-dimensional coordinates including a longitude, a latitude and a height), a curvature of a curve of a lane, positions of merging and branching points of lanes, marks provided on a road, and so on.

The host vehicle position recognition part 122 of the automated driving controller 120 recognizes a lane on which the host vehicle M is traveling (a target lane) and a relative position of the host vehicle M with respect to the target lane on the basis of the high accuracy map information 182 stored in the storage 180 and the information input from the finders 20, the radars 30, the camera 40, the navigation device 50 or the vehicle sensor 60.

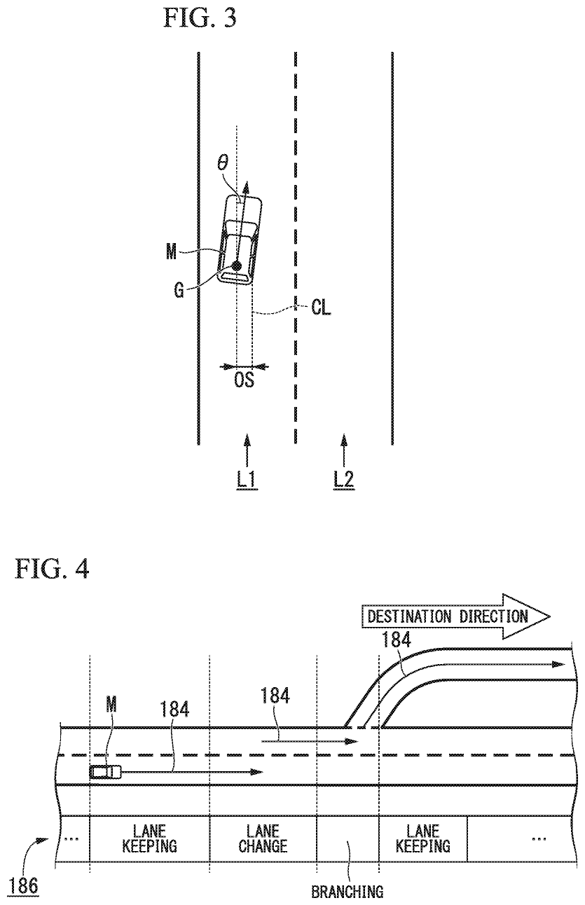

FIG. 3 is a figure showing an aspect in which a relative position of the host vehicle M with respect to a target lane L1 is recognized by the host vehicle position recognition part 122. The host vehicle position recognition part 122 recognizes, for example, a deviation OS from a target lane center CL of a reference point G (for example, a center of gravity, a center of a rear wheel shaft, or the like) of the host vehicle M, and an angle θ formed by a direction of advance of the host vehicle M with respect to the target lane center CL as a relative position of the host vehicle M with respect to the target lane L1.

Further, instead of this, the host vehicle position recognition part 122 may recognize a position of a reference point of the host vehicle M with respect to any one of side end portions of an own traffic lane L1 as a relative position of the host vehicle M with respect to the target lane. The relative position of the host vehicle M recognized by the host vehicle position recognition part 122 is provided to the target lane determining part 110.

The outside recognition part 124 recognizes a state such as a position, a speed, an acceleration, or the like, of a neighboring vehicle on the basis of the information input from the finders 20, the radars 30, the camera 40, and so on.

The neighboring vehicle is a vehicle that is traveling around the host vehicle M, and a vehicle that is traveling in the same direction as the host vehicle M. A position of the neighboring vehicle may be represented as a reference point including a center of gravity, a corner, or the like, of another vehicle, or may be represented as a region expressed as a profile of another vehicle.

“The state” of the neighboring vehicle may include whether acceleration or lane change of the neighboring vehicle is being performed (or whether the lane change is to be performed) that is ascertained on the basis of information from the various instruments.

In addition, the outside recognition part 124 may recognize a position of a guard rail, an electric pole, a parked vehicle, a pedestrian, and other substance, in addition to a neighboring vehicle.

The action plan generating part 126 sets a start point of automated driving and/or a destination of automated driving. The start point of automated driving may be a current position of the host vehicle M or may be a point at which an operation of instructing automated driving is performed. The action plan generating part 126 generates an action plan in a section between the start point and the destination of automated driving. Further, there is no limitation thereto, and the action plan generating part 126 may generate an action plan in an arbitrary section.

The action plan is constituted by, for example, a plurality of events, which are performed in sequence.

The event includes, for example, a deceleration event of decelerating the host vehicle M, an acceleration event of accelerating the host vehicle M, a lane keeping event of causing the host vehicle M to travel and not to deviate from a target lane, a lane change event of changing target lanes, an overtaking event of causing the host vehicle M to overtake a preceding vehicle, a branching event of changing to a predetermined lane at an branching point or causing the host vehicle M to travel such that it does not deviate from the current target lane, a merging event of accelerating and decelerating the host vehicle M at a merging lane to join the main line and changing target lanes, and so on.

The action plan generating part 126 sets a lane change event, a branching event, or a merging event at a place in which the target lane determined by the target lane determining part 110 is switched.

The information that represents the action plan generated by the action plan generating part 126 is stored in the storage 180 as the action plan information 186.

FIG. 4 is a figure showing an example of an action plan generated in a certain section. As shown in FIG. 4, the action plan generating part 126 generates an action plan required for the host vehicle M to travel on the target lane represented by the target lane information 184. Further, the action plan generating part 126 may dynamically change the action plan according to variation in circumstances of the host vehicle M regardless of the target lane information 184.

For example, the action plan generating part 126 may change an event set to a driving section to which the host vehicle M will travel when a speed of a neighboring vehicle recognized by the outside recognition part 124 while the vehicle is traveling exceeds a threshold value or when a moving direction of a neighboring vehicle that is traveling on a lane adjacent to the own traffic lane is oriented toward a direction of the own traffic lane.

For example, in the case in which an event is set such that a lane change event is performed after a lane keeping event, when it is determined that a vehicle is advancing at a speed of a threshold value or more from the rear in a lane to which the lane change is possible during the lane keeping event according to the recognition results of the outside recognition part 124, the action plan generating part 126 may change the event after the lane keeping event from a lane change event to a deceleration event, a lane keeping event, or the like. As a result, the vehicle control system 100 enables safe automated traveling of the host vehicle M even when a variation occurs in an outside state.

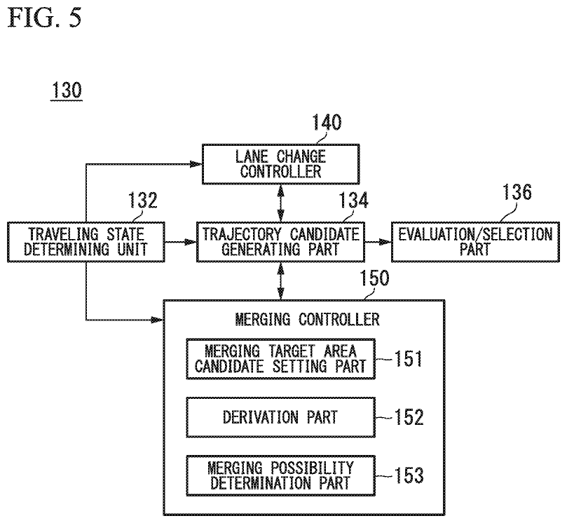

FIG. 5 is a figure showing an example of a configuration of the trajectory generating part 130. The trajectory generating part 130 includes, for example, a traveling state determining unit 132, a trajectory candidate generating part 134, an evaluation/selection part 136, a lane change controller 140 and a merging controller 150.

The traveling state determining unit 132 determines a traveling aspect of any one of constant speed traveling, following traveling, deceleration traveling, curve traveling, obstacle avoidance traveling, and so on, when a lane keeping event is executed.

For example, the traveling state determining unit 132 may determine the traveling aspect as constant speed traveling when another vehicle is not present in front of the host vehicle M.

In addition, the traveling state determining unit 132 may determine the traveling aspect as following traveling when the host vehicle follows a preceding vehicle.

In addition, the traveling state determining unit 132 may determine the traveling aspect as deceleration traveling when deceleration of preceding vehicle is recognized by the outside recognition part 124 or when an event such as stopping, parking, or the like, is executed.

In addition, the traveling state determining unit 132 may determine the traveling aspect as curve traveling when it is recognized by outside recognition part 124 that the host vehicle M is approaching a curve road.

In addition, the traveling state determining unit 132 may determine the traveling aspect as obstacle avoidance traveling when an obstacle in front of the host vehicle M is recognized by the outside recognition part 124.

The trajectory candidate generating part 134 generates trajectory candidates on the basis of the traveling aspect determined by the traveling state determining unit 132. The trajectory of the embodiment is a collection of target positions (trajectory points) at which a reference position (for example, a center of gravity, a center of a rear wheel shaft, or the like) of the host vehicle M is assumed to reach at predetermined intervals (or each of predetermined traveling distances) in the future.

The trajectory candidate generating part 134 calculates a target speed of the host vehicle M on the basis of at least a speed of an object OB present in front of the host vehicle M recognized by the outside recognition part 124 and a distance between the host vehicle M and the object OB.

The trajectory candidate generating part 134 generates one or more trajectories on the basis of the calculated target speed. The object OB includes a preceding vehicle, a point such as a merging point, a branching point, a target point, or the like, a body such as an obstacle or the like, and so on.

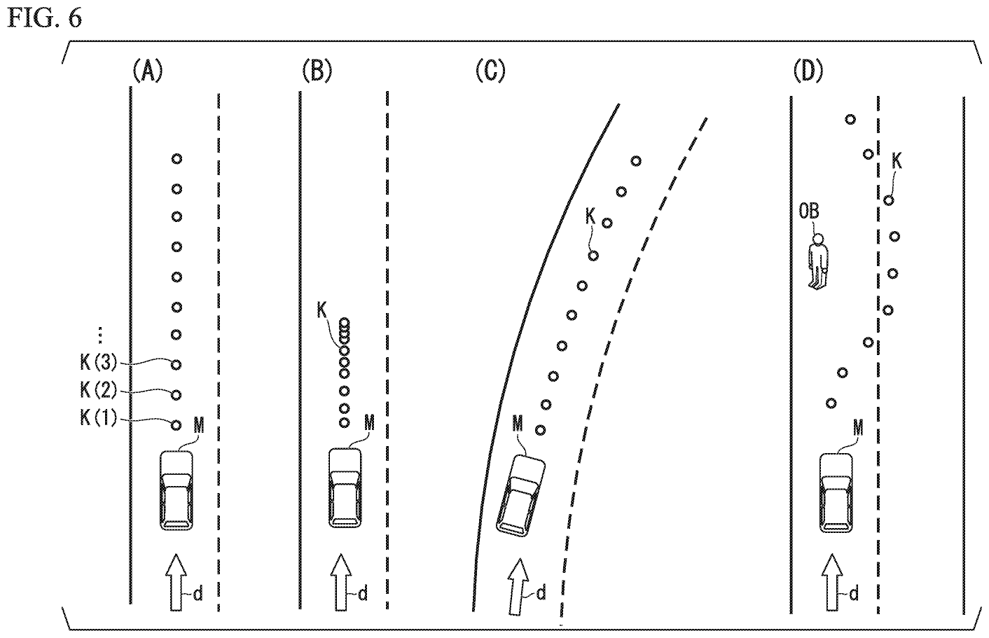

FIG. 6 is a figure showing an example of trajectory candidates generated by the trajectory candidate generating part 134.

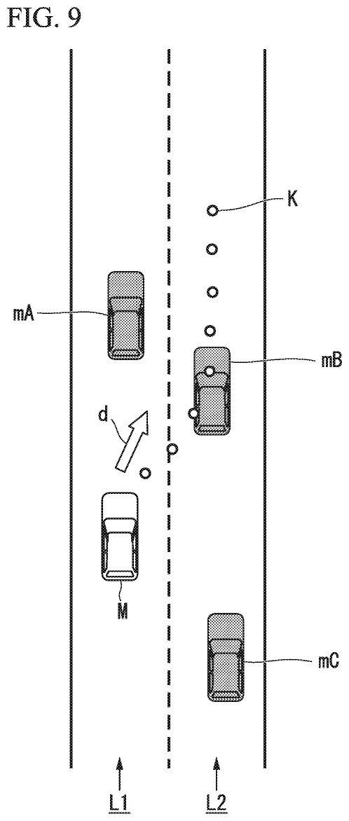

Further, in FIG. 6 and FIG. 9 that is to be described below, only a representative trajectory among a plurality of trajectory candidates that are set, or a trajectory selected by the evaluation/selection part 136 are noted and described. As shown in part (A) of FIG. 6, for example, the trajectory candidate generating part 134 sets trajectory points that are referred to as K(1), K(2), K(3), . . . whenever a predetermined time Δt elapses from the current time with reference to the current position of the host vehicle M. Hereinafter, when the trajectory points are not distinguished, they are simply expressed as “a trajectory point K.”

When the traveling aspect is determined as constant speed traveling by the traveling state determining unit 132, as shown in part (A) of FIG. 6, the trajectory candidate generating part 134 sets the plurality of trajectory points K at equal intervals. When such a simple trajectory is generated, the trajectory candidate generating part 134 may generate only one trajectory.

When the traveling aspect is determined as deceleration traveling by the traveling state determining unit 132 (including when a preceding vehicle decelerates in following traveling), as shown in part (B) of FIG. 6, the trajectory candidate generating part 134 generates a trajectory by widening the interval between the trajectory points K having an earlier arrival time and narrowing the interval between the trajectory points K having a later arrival time. In this case, the preceding vehicle may be set as the object OB, or in addition to the preceding vehicle, a point such as a merging point, a branching point, a target point, or the like, an obstacle, or the like, may be set as the object OB. Accordingly, since the current position of the host vehicle M approaches the trajectory point K having a later arrival time from the host vehicle M, the traveling controller 160, which will be described below, causes the host vehicle M to decelerate.

When the traveling aspect is determined as curve traveling by the traveling state determining unit 132, as shown in part (C) of FIG. 6, the trajectory candidate generating part 134 disposes the plurality of trajectory points K according to a curvature of the road while changing a lateral position in the direction of advance of the host vehicle M (a position in a lane width direction).

In addition, as shown in part (D) of FIG. 6, when the obstacle OB such as a person, a stopped vehicle, or the like, is present on a road in front of the host vehicle M, the trajectory candidate generating part 134 disposes the plurality of trajectory points K such that the host vehicle travels while avoiding the obstacle OB.

The evaluation/selection part 136 performs, for example, evaluation from two viewpoints of planning and safety and selects the trajectory output to the traveling controller 160 with respect to the trajectory candidates generated by the trajectory candidate generating part 134. From a viewpoint of planning, for example, a trajectory is highly evaluated when trackability with respect to an already generated plan (for example, an action plan) is higher, and when the entire length of the trajectory is shorter. For example, when changing lanes to the right is desired, the trajectory which changes the lane to the left once and returns is evaluated low. From a viewpoint of safety, for example, it is evaluated higher as a distance between the host vehicle M and a body (a neighboring vehicle or the like) is larger and variation or the like in acceleration and deceleration or steering angle is smaller.

The lane change controller 140 is operated when the lane change event, the branching event, the merging event, or the like, is executed, i.e., when lane change in a broad sense is executed.

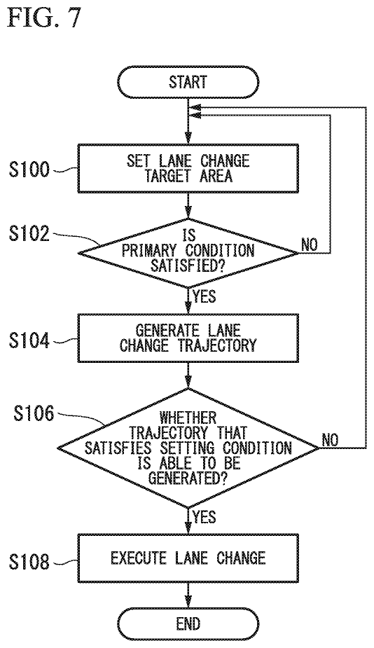

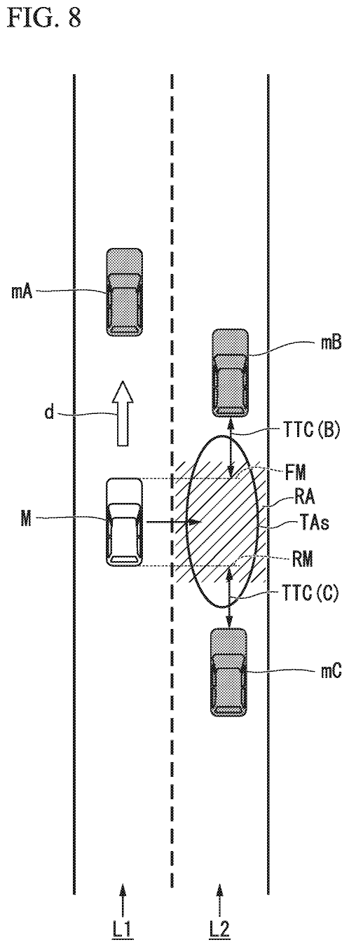

FIG. 7 is a flowchart showing an example of a flow of processing performed when a lane change event is executed. The processing will be described with reference to FIGS. 7 and 8.

First, the lane change controller 140 selects two neighboring vehicles from neighboring vehicles which are traveling on an adjacent lane, which is the lane adjacent to a lane (an own traffic lane) on which the host vehicle M is traveling, and that is the lane to which the lane change is performed, and sets a lane change target area TAs between the neighboring vehicles (step S100).

Hereinafter, a neighboring vehicle that is traveling in front of the lane change target area TAs on the adjacent lane is referred to as a preceding reference vehicle mB, and a neighboring vehicle that is traveling at rear of the lane change target area TAs on the adjacent lane is referred to as a following reference vehicle mC and neighboring vehicles will be described. The lane change target area TAs is a relative position on the basis of a positional relationship between the host vehicle M, the preceding reference vehicle mB and the following reference vehicle mC.

FIG. 8 is a figure showing an aspect in which the lane change target area TAs is set. In FIG. 8, mA represents a preceding vehicle, mB represents a preceding reference vehicle, and mC represents a following reference vehicle. In addition, an arrow d represents a direction of advance (traveling) of the host vehicle M, L1 represents an own traffic lane, and L2 represents an adjacent lane.

In the case of FIG. 8, the lane change controller 140 sets the lane change target area TAs between the preceding reference vehicle mB and the following reference vehicle mC on the adjacent lane L2.

Next, the lane change controller 140 determines whether a primary condition for determining whether lane change to the lane change target area TAs (i.e., between the preceding reference vehicle mB and the following reference vehicle mC) is possible is satisfied (step S102).

For example, the primary condition is that none of a part of the neighboring vehicle is present in a forbidden region RA formed on the adjacent lane and each of TTCs (Time-to-Collision) between the host vehicle M, the preceding reference vehicle mB and the following reference vehicle mC is larger than a threshold value.

Further, this determination condition is an example of a case in which the lane change target area TAs is set to a side of the host vehicle M.

When the primary condition is not satisfied, the processing of the lane change controller 140 returns to step S100 and the lane change target area TAs is reset.

Here, speed control for moving the host vehicle to a side of the lane change target area TAs may be performed by waiting until a timing when the primary condition is satisfied and the target area TAs can be set or by changing the lane change target area TAs.

As shown in FIG. 8, for example, the lane change controller 140 projects the host vehicle M to the lane L2 to which the lane change is to be performed, and sets the forbidden region RA which includes a slight marginal distance maintained in a forward/rearward direction. The forbidden region RA is set as a region extending from one end to the other end in a lateral direction of the lane L2.

When a neighboring vehicle is not present in the forbidden region RA, for example, the lane change controller 140 assumes an extension line FM and an extension line RM virtually extending from a front end and a rear end of the host vehicle M, respectively, toward the lane L2 to which the lane change is to be performed.

The lane change controller 140 calculates a time to collision TTC(B) between the extension line FM and the preceding reference vehicle mB, and a following reference vehicle TTC(C) between the extension line RM and the following reference vehicle mC.

The time to collision TTC(B) is a time derived by dividing a distance between the extension line FM and the preceding reference vehicle mB by a relative speed between the host vehicle M and the preceding reference vehicle mB.

The time to collision TTC(C) is a time derived by dividing a distance between the extension line RM and the following reference vehicle mC by a relative speed between the host vehicle M and the following reference vehicle mC.

The trajectory candidate generating part 134 determines that the primary condition is satisfied when the time to collision TTC(B) is larger than a threshold value Th(B) and the time to collision TTC(C) is larger than a threshold value Th(C).

The threshold values Th(B) and Th(C) may be the same value or may be different values.

When the primary condition is satisfied, the lane change controller 140 generates trajectory candidates for lane change using the trajectory candidate generating part 134 (step S104).

FIG. 9 is a figure showing an aspect in which a trajectory for lane change is generated. For example, the trajectory candidate generating part 134 assumes that the preceding vehicle mA, the preceding reference vehicle mB and the following reference vehicle mC are traveling in a predetermined speed model, and generates trajectory candidates so that the host vehicle M is disposed between the preceding reference vehicle mB and the following reference vehicle mC at a time in the future on the basis of the speed model of the three vehicles and the speed of the host vehicle M so that the host vehicle M and the preceding vehicle mA do not interfere or contact with each other.

For example, the trajectory candidate generating part 134 smoothly connects the current position of the host vehicle M with a position of the preceding reference vehicle mB in a certain time in the future, a center of a lane to which lane change is to be performed and an end point for the lane change using a polynomial curve line of a spline curve line or the like, and disposes a predetermined number of trajectory points K at equal intervals or non-equal intervals on the curve line.

Here, the trajectory candidate generating part 134 generates a trajectory such that at least one of the trajectory points K is disposed in the lane change target area TAs.

Next, the evaluation/selection part 136 determines whether trajectory candidates that satisfy a setting condition have been generated (step S106). The setting condition means that, for example, an evaluation value of a threshold value or more is obtained from the viewpoint of the above-mentioned planning or safety.

When trajectory candidates that satisfy the setting condition are generated, for example, the evaluation/selection part 136 performs the lane change by selecting a trajectory candidate having the highest evaluation value and outputting the trajectory information to the traveling controller 160 (step S108).

Meanwhile, when a trajectory that satisfies the setting condition is not generated, the processing returns to step S100. Here, like the case in which a negative determination is obtained in step S102, processing of becoming a standby state or resetting the lane change target area TAs may be performed.

The traveling controller 160 shown in FIG. 2 controls the driving force output apparatus 90, the steering apparatus 92 and the brake apparatus 94 such that the host vehicle M passes along the trajectory generated by the trajectory candidate generating part 134 in the scheduled time.

The trajectory candidate generating part 134 and the traveling controller 160, which are described above, are an example of “a second controller.”

The switching controller 170 switches a driving mode on the basis of an operation of instructing acceleration, deceleration or steering with respect to the operation device 70, in addition to switching a driving mode on the basis of the driving mode designating signal input from the selector switch 80.

For example, the switching controller 170 may switch the driving mode from an automated driving mode to a manual driving mode when a state in which the operation amount input from the operation detecting sensor 72 exceeds a threshold value is maintained for a reference time or more.

In addition, the switching controller 170 may switch the driving mode from the automated driving mode to the manual driving mode in the vicinity of a destination of automated driving.

The switching controller 170 performs switching of the control mode on the basis of the driving mode designating signal input from the selector switch 80 when the control mode is switched from the manual driving mode to the automated driving mode. In addition, after the control mode is switched from the automated driving mode to the manual driving mode, the control of returning to the automated driving mode may be performed when an operation of instructing acceleration, deceleration or steering with respect to the operation device 70 is not detected for a predetermined time.

### Merging Control

Hereinafter, merging control will be described. As shown in FIG. 5, the merging controller 150 includes, for example, a merging target area candidate setting part 151, a derivation part 152, and a determination part 153 configured to determine whether merging is possible.

The merging controller 150 is started by the traveling state determining unit 132, for example, when the host vehicle M starts to travel along a branch line (an acceleration lane) that merges onto a main line. The merging controller 150 is an example of “a first controller.”

The merging target area candidate setting part 151 sets one or more merging target area candidates cTAg that are candidates of a merging target area TAg which the host vehicle M uses as a target when joining the main line.

The merging target area TAg is a relative position set between neighboring vehicles that are traveling on the main line to which the host vehicle M will join.

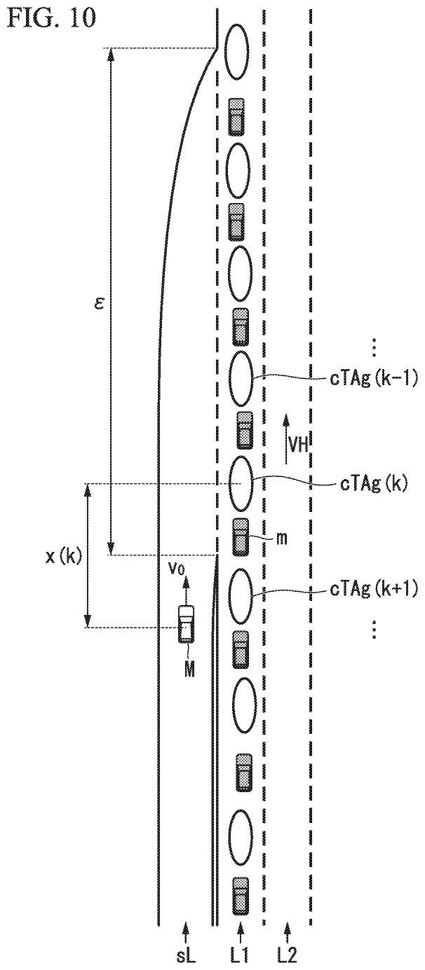

FIG. 10 is a figure exemplarily showing the merging target area candidates cTAg set by the merging target area candidate setting part 151.

As shown in FIG. 10, the merging target area candidate setting part 151 selects n neighboring vehicles m that are traveling on the lane L1 among the main line adjacent to a branch line sL, and sets the one or more merging target area candidates cTAg between the selected neighboring vehicles m.

Hereinafter, these are represented as the merging target area candidates cTAg(k) (k=1 to n-1). Here, n is an arbitrary natural number.

The merging target area candidate setting part 151 may select n neighboring vehicles m according to an arbitrary restriction such as for selecting a total of 10 neighboring vehicles m, for example, 5 neighboring vehicles m traveling in front of the host vehicle M in a direction of advance and 5 neighboring vehicles m traveling in rear of the host vehicle M in the direction of advance.

In addition, the merging target area candidate setting part 151 may set the merging target area candidates cTAg by excluding a case in which an inter-vehicle distance between the neighboring vehicles m that are traveling immediately in front of and immediately in rear of the host vehicle is shorter than a reference distance or a case in which the inter-vehicle distance is equal to or shorter than a reference distance after a reference time has elapsed while the relative speed has been considered.

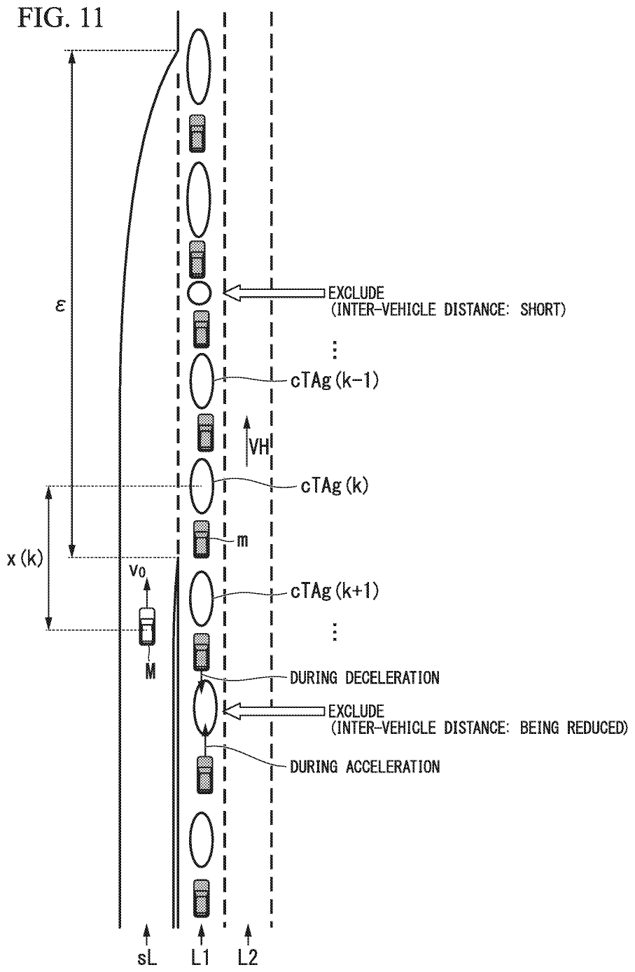

FIG. 11 is a figure showing another example of the merging target area candidates cTAg set by the merging target area candidate setting part 151.

Hereinafter, a distance between the merging target area candidates cTAg(k) and the host vehicle M is represented as x(k), and an average speed of the neighboring vehicles m that are traveling on the lane L1 is represented as VH. The average speed VH is, for example, information included in the traffic condition information acquired by the communication device 75. In addition, the average speed VH may be acquired by obtaining an average of speeds of the neighboring vehicles m recognized by the outside recognition part 124.

In addition, ε in FIGS. 10 and 11 represents a distance (a length) in a direction of vehicle advance in a section, in which the host vehicle M is able to travel when the host vehicle M joins the lane L1 from the branch line sL, at a point (a merging point) at which the branch line sL merges with the lane L1 which is the main line.

The distance ε may be derived on the basis of, for example, information such as the number of lanes of a road, widths of lanes, positions of a merging points of lanes, and so on, included in the high accuracy map information 182.

In addition, the distance ε may be derived on the basis of a length, a shape, or the like, of a road partition line recognized by the outside recognition part 124.

Hereinafter, the distance ε will be referred to as “a merging road length ε” and will be described.

The derivation part 152 derives a merging road length ε at a boundary point between a main line to which the host vehicle M is going to join and a branch line by using the high accuracy map information 182, and derives a success probability of merging by referring to the correspondence information 188 stored in the storage 180 and by on the basis of the derived merging road length ε and a vehicle-to-vehicle gap time δ(k) included in the traffic condition information acquired by the communication device 75.

The determination part 153 determines whether the host vehicle M is able to join the main line on the basis of the success probability derived by the derivation part 152 at each of the merging target area candidates cTAg(k).

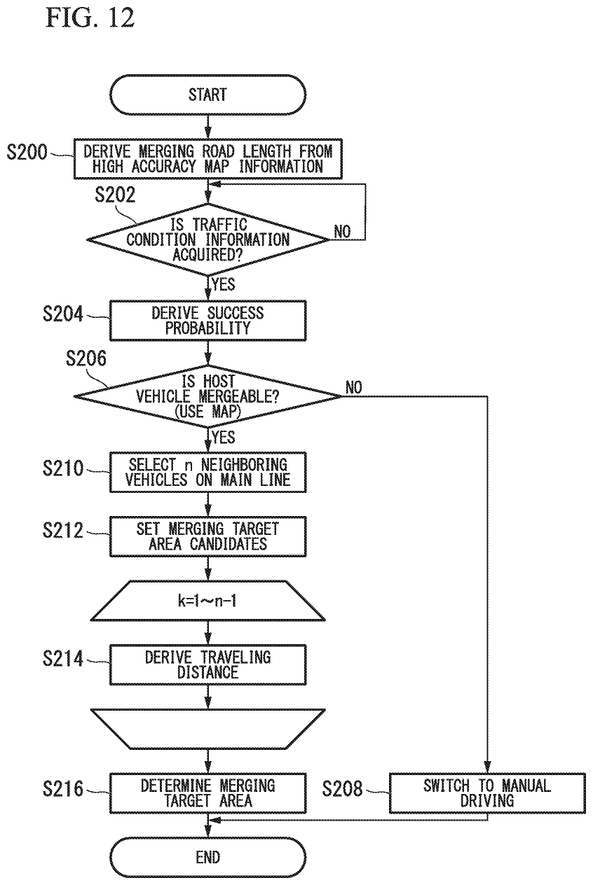

Hereinafter, a sequence of processing of the merging controller 150 will be described in accordance with a flowchart. FIG. 12 is a flowchart showing an example of a flow of processing of the merging controller 150 according to the first embodiment.

First, the derivation part 152 derives a merging road length ε at a boundary point between a main line to which the host vehicle M is going to join and a branch line by using the high accuracy map information 182 (step S200).

Next, the derivation part 152 waits until traffic condition information is acquired by the communication device 75 (step S202), and, when the traffic condition information is acquired by the communication device 75, derives a success probability by referring to the correspondence information 188 stored in the storage 180 and by on the basis of the derived merging road length ε and the vehicle-to-vehicle gap time δ(k) included in the traffic condition information acquired by the communication device 75 (step S204).

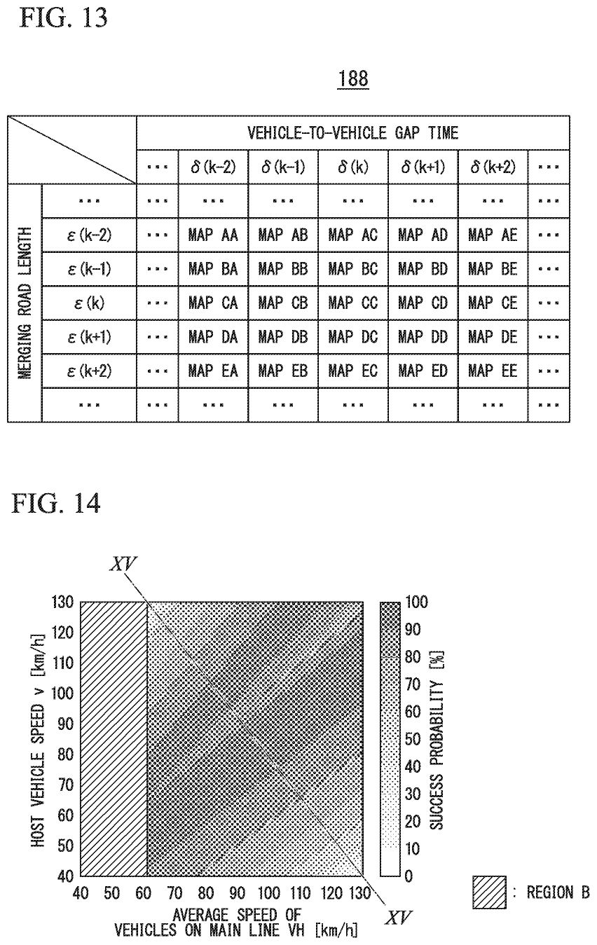

FIG. 13 is a figure showing an example of the correspondence information 188 according to the first embodiment. As shown in FIG. 13, for example, the correspondence information 188 includes maps corresponding to the vehicle-to-vehicle gap times δ(k) and the merging road lengths ε(k).

The merging road length ε(k) represent, for example, distances at predetermined intervals such as ε(1)=10 m and ε(2)=20 m. Further, the correspondence information 188 may be a table corresponding to the map, and may be a function using the vehicle-to-vehicle gap time δ(k), the merging road length ε(k), the speed v of the host vehicle M, and the average speed VH of the vehicles on the main line as elements.

In the following examples, it will be described as being a map.

For example, the derivation part 152 selects a map having values that coincide with or are closest to both of the derived merging road length c and the vehicle-to-vehicle gap time δ(k) included in the traffic condition information with reference to the high accuracy map information 182.

FIG. 14 is a figure showing an example of a certain map in the correspondence information 188 of the first embodiment. A horizontal axis in FIG. 14 represents an average speed VH of vehicles on the main line, a vertical axis represents the speed v of the host vehicle M at the time of entering a section that is able to be joined, and a color bar on the right side of the map represents a success probability upon merging as colors (graduations) and numerical values (0 to 100% in FIG. 14).

Further, numerical values of the success probability shown in FIG. 14 are only an example, and a range of acceptable probability may exceed 100%.

For example, on the map, areas in which success probabilities are equal are represented by the same pattern (color, graduation).

The map represents results obtained by performing the best speed control when the best merging target area Tag is selected. “The best merging target area TAg(k)” is a merging target area in which a traveling distance RD(k) is shortest among the plurality of merging target area candidates cTAg(k).

In addition, the success probability derived from each map is a ratio between the merging road length ε(k) and the traveling distance RD(k), which is required for arrival at the best merging target area TAg(k), for example, in a case conditions such as (1) all vehicles that are traveling on the main line to which a branch line merges are traveling at the average speed VH, (2) inter-vehicle distances between the vehicles that are traveling on the main line are equidistant (i.e., a vehicle-to-vehicle gap time δ(k) is constant), and (3) a speed (or an acceleration or the like) of the host vehicle M at a point at which a merging event is started is constant, are assumed.

For example, the success probability may be represented by ε/RD(k), (1-RD(k)/ε), or the like. That is, the success probability varies with a tendency such that the success probability decreases as the traveling distance RD(k) with respect to the merging road length ε(k) increases, and the success probability increases as the traveling distance RD(k) decreases.

In addition, a region B in FIG. 14 represents a region in which an inter-vehicle distance between the neighboring vehicles m that are traveling immediately in front of and immediately in rear of the merging target area candidates cTAg is a reference distance or less. For the region B, it is determined by the determination part 153 to be described later that merging is not possible without taking into account the success probability.

With regard to a respective average speed VH and a speed v of the host vehicle M, respectively, the increase/decrease tendency of the success probability discontinuously varies. That is, the increase/decrease tendency of the traveling distance RD(k) which is the basis of the success probability discontinuously varies with regard to the respective average speed VH and the speed v of the host vehicle M.

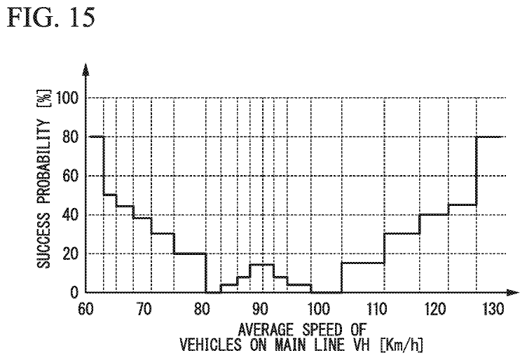

FIG. 15 is a figure showing an aspect of a variation in success probability on line XV-XV in FIG. 14.

A horizontal axis in FIG. 15 represents an average speed VH of vehicles on the main line, and a vertical axis represents success probability. As shown in FIG. 15, the success probability symmetrically varies at a speed increase side and a speed decrease side while having the average speed VH of 90 km/h in the center.

In addition, in the vicinity of a central value of 90 km/h, as the average speed VH increase, a value obtained by differentiating the trend of the success probability variation changes from a negative value to a positive value, and then changes from the positive value to the negative value. In the case of such tendency, it means that there are at least two candidates having extreme values at which the success probability is minimized, and a speed v of the host vehicle M upon merging is set to a speed corresponding to any one of these extreme values.

For example, among the two candidates for the speed v of the host vehicle M, the candidate having a larger speed is excluded because it exceeds an upper limit value of a legal speed limit or the like, and the other candidate is employed.

The above-mentioned map is a map in which the vehicle-to-vehicle gap time δ(k), the merging road length ε(k), the speed v of the host vehicle M and the average speed VH of the vehicles on the main line are used as parameters (elements), and in which success probability values obtained through simulation while independently changing at least these parameters are drawn in a contour map shape.

For example, a traveling time required from the current position of the host vehicle M upon merging to the merging target area candidates cTAg(k) is derived at each of the merging target area candidates cTAg(k) while assuming that the host vehicle M is traveling on the basis of a movement model in which a future state is predictable, such as a constant acceleration model, a constant jerk (jerk degree) model, or the like.

Here, when the host vehicle M is traveling on the basis of the assumed movement model, the upper limit speed may be set with respect to a speed that can be output by the host vehicle M. The upper limit speed is, for example, a legal speed limit or the like.

Then, the traveling distance RD(k) to arrival at the merging target area candidates cTAg(k) is derived at each of the merging target area candidates cTAg(k) on the basis of the derived traveling time and the movement model of the host vehicle M.

The processing performed previously will be described in detail in the following processing of S214.

Next, electing a merging target area candidates cTAg(k) which has the shortest traveling distance RD(k) among the each of the traveling distance RD(k) derived for the respective merging target area candidates cTAg(k), and, regarding to this merging target area candidates cTAg(k), a map is generated in which the elected traveling distance RD(k) is replaced with a probability based on a ratio with respect to the merging road length ε(k). That is, the correspondence information 188 is information in which maps having the best conditions are previously stored.

Further, in the maps in the correspondence information 188, in each of the merging target area candidates cTAg(k) on the merging lane, the traveling distance RD(k) is derived while assuming the case in which an initial position displacement d(k) is largest.

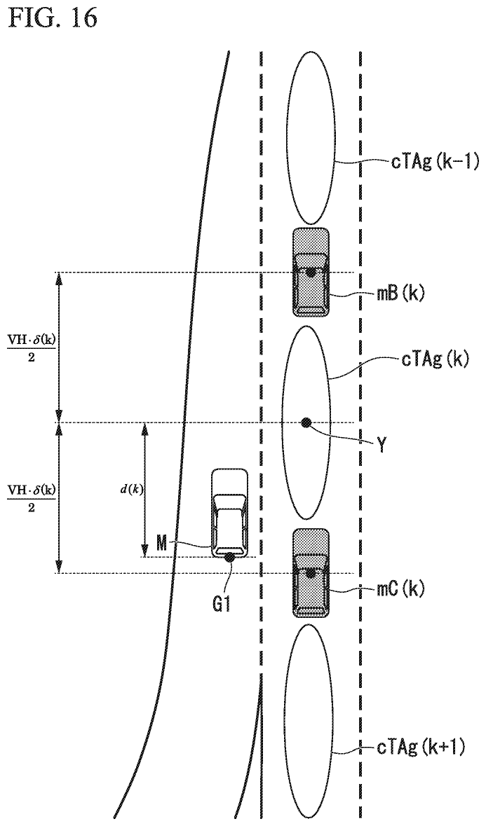

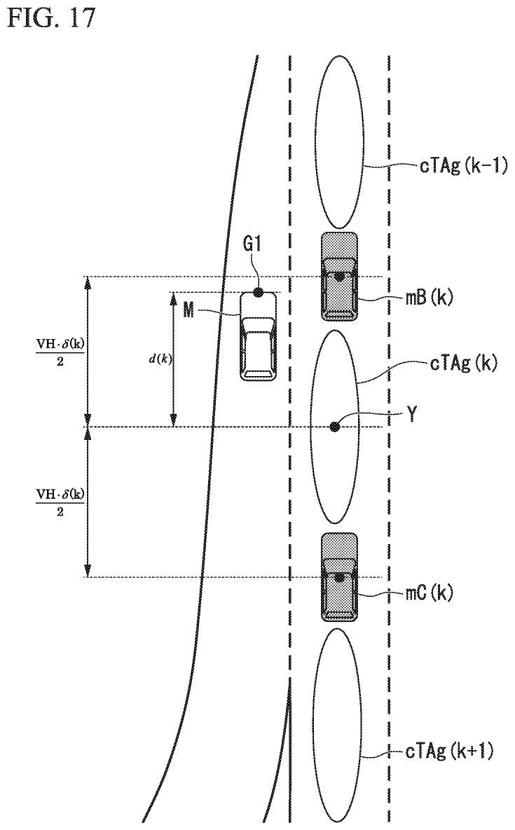

FIGS. 16 and 17 are figures for explaining the initial position displacement d(k).

As shown in FIGS. 16 and 17, when the host vehicle M is traveling parallel to a certain merging target area candidate cTAg(k), the initial position displacement d(k) is represented as a distance from a reference position G1 of the host vehicle M to a reference position Y of each of the merging target area candidates cTAg(k) along which the host vehicle is traveling in a direction of advance of the host vehicle M.

Further, the reference position Y of each of the merging target area candidates cTAg(k) will be described as an intermediate position between vehicles in front of and in rear of the host vehicle which is interposed therebetween.

For example, when the host vehicle M adjusts a position thereof while accelerating from the rear of the merging target area candidate cTAg(k), as shown in FIG. 16, the reference position G1 of the host vehicle M is set to the rear with respect to the reference position Y of the merging target area candidate cTAg(k) such that a distance required until the reference position G1 of the host vehicle M coincides with the reference position Y of the merging target area candidate cTAg(k) is maximized, and simulation (or an experiment or the like) is performed.

In addition, when the host vehicle M adjusts a position thereof while decelerating or maintaining a speed from the front of the merging target area candidate cTAg(k), as shown in FIG. 17, the reference position G1 of the host vehicle M is set in front with respect to the reference position Y of the merging target area candidate cTAg(k) such that a distance required until the reference position G1 of the host vehicle M coincides with the reference position Y of the merging target area candidate cTAg(k) is maximized, and simulation (or an experiment or the like) is performed.

Since the initial position displacement d(k) is one of external factors that are relatively invariable under control of the host vehicle M, upon generation of a map, in order to maximize the initial position displacement d(k), the reference position G1 of the host vehicle M is set in a direction so that a traveling distance is further increased when coinciding with the reference position Y of the merging target area candidate cTAg(k).

Accordingly, the traveling distance RD(k) can be derived by assuming circumstances in which the merging is most difficult. That is, low success probability can be previously derived by assuming the circumstances in which the merging is most difficult.

As a result, the automated driving controller 120 can control the host vehicle M more safely.

The determination part 153 determines whether the host vehicle M can join the main line on the basis of the success probability derived by the derivation part 152 (step S206).

For example, the determination part 153 determines that the host vehicle M cannot join the main line by deciding that the traveling distance RD(k) for adjusting the speed is not enough when the success probability derived by the derivation part 152 is a threshold value or less.

In this case, the determination part 153 causes the switching controller 170 to perform switching processing such that the driving mode is changed from the automated driving mode to the manual driving mode while informing a driver of that the merging event cannot be performed with the automated driving using the display 62 or the speaker 64 (step S208).

Accordingly, the vehicle control system 100 can change an operation of the host vehicle M to a driver before the host vehicle M enters a merging road on which a speed is adjusted.

In addition, when it is determined by the determination part 153 that the host vehicle M cannot join the main line, the target lane determining part 110 may change a part of a route provided from the navigation device 50 and set a target lane to another lane.

Accordingly, the vehicle control system 100 can cause the host vehicle M to travel to a destination in a state in which the automated driving is continued using, for example, a route that bypasses another merging point or a route on which a merging point is not present.

Meanwhile, the determination part 153 determines that the host vehicle M can join the main line by deciding that the traveling distance RD(k) for adjusting a speed is sufficient when the success probability derived by the derivation part 152 is the threshold value or more.

Next, when the host vehicle M can join the main line, the merging target area candidate setting part 151 selects n neighboring vehicles m that are traveling on a lane of the main line adjacent to a branch line (step S210), and sets one or more merging target area candidates cTAg between the selected neighboring vehicles m (step S212).

Next, the derivation part 152 derives the traveling distance RD(k) at each of the merging target area candidates cTAg(k) set by the merging target area candidate setting part 151 (step S214).

For example, the derivation part 152 derives a speed v(k, t) and an arrival time T{cTAg(k)} of the host vehicle M under the following restrictions of (1) to (3).

(1) The host vehicle M is traveling on the basis of a movement model in which a future state is predictable, such as a constant acceleration model, a constant jerk (jerk degree) model, or the like, and an upper limit speed is determined. The upper limit speed is, for example, a legal speed limit.

(2) A speed (variation) v(k, t) of the host vehicle M corresponding to the merging target area candidate cTAg(k) coincides with the average speed VH at the time the host vehicle M arrives at the merging target area candidate cTAg(k).

(3) Duration to an arrival time T{cTAg(k)}, a value obtained by integrating a difference between the speed v(k, t) of the host vehicle M and VH coincides with a distance x(k) between the merging target area candidate cTAg(k) and the host vehicle M.

Then, the derivation part 152 derives the traveling distance RD(k) until the host vehicle M arrives at the merging target area candidate cTAg(k) on the basis of the speed v (k, t) and the arrival time T{cTAg(k)} of the host vehicle, which were derived.

Here, like the movement model of the host vehicle M, the vehicles that are traveling immediately in front of and immediately at rear of the merging target area candidate cTAg(k) are assumed to travel on the basis of the movement model in which a future state is predictable, such as a constant acceleration model, a constant jerk (jerk degree) model, or the like.

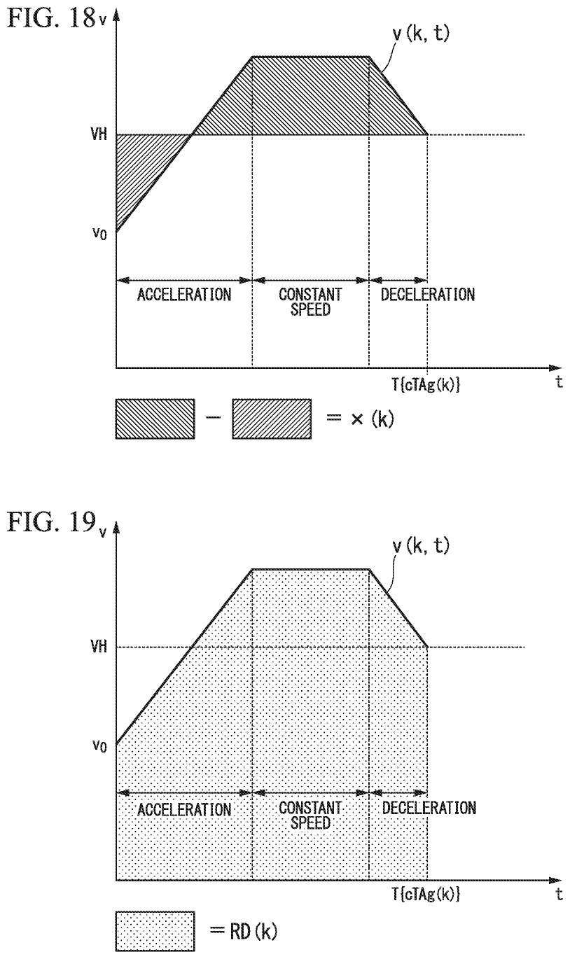

FIG. 18 is a figure showing an example of the speed v(k, t) of the host vehicle M that satisfies the above-mentioned conditions (1) to (3). In FIG. 18, v₀ is a speed of the host vehicle M at the time the merging is determined, and an initial value of the speed v(k, t). As shown in FIG. 18, under the condition in which Equation (1) and the condition (2) are established, the speed v(k, t) and the arrival time T{cTAg(k)} of the host vehicle are obtained.

[Math. 1]

x(k)=∫₀^{T{cTAg(k)}}{v(k,t)−VH}dt (1)

For example, the derivation part 152 derives the speed v(k, t) that satisfies the conditions by searching a pattern that matches with the conditions while variously changing an acceleration duration, a constant speed duration and a deceleration duration shown in FIG. 18.

In addition, the map corresponding to a pattern of the parameter such as x(k), v₀, VH, or the like, and the speed v(k, t) is stored in the storage 180, and the derivation part 152 may derive the speed v(k, t) by applying the parameters to the map.

In addition, the derivation part 152 may hold a map having coarse accuracy, and may perform searching using the speed v(k, t) derived from the coarse map as an origin.

This also applies to each of embodiment, which will be described below.

The derivation part 152 derives the traveling distance RD(k) until the host vehicle M arrives at the merging target area candidate cTAg(k) on the basis of the speed v(k, t) and the arrival time T{cTAg(k)} of the host vehicle, which were derived. The traveling distance RD(k) is obtained by Equation (2).

FIG. 19 is a figure for explaining the processing by the derivation part 152.

[Math. 2]

RD(k)=∫₀^{T{cTAg(k)}}v(k,t)dt (2)

Next, the merging target area candidate setting part 151 determines a merging target area candidate cTAg(k) in which the traveling distance RD(k) derived for each of the merging target area candidates cTAg(k) is smallest as a merging target area TAg(k) to which the host vehicle M should enter during merging (step S216).

Then, the merging target area candidate setting part 151 generates trajectory candidates directed toward the merging target area TAg(k) using the trajectory candidate generating part 134.

Here, the trajectory candidate generating part 134 generates trajectory candidates directed toward the merging target area TAg(k) using the speed v of the host vehicle M assumed upon derivation of the traveling distance RD(k). Then, the evaluation/selection part 136 determines a trajectory using for control among the trajectory candidates, and the merging is performed as the traveling controller 160 controls a control object on the basis of this trajectory.

According to the vehicle control system 100 of the above-mentioned first embodiment, traffic condition information of the main line to which the host vehicle M is going to join from the branch line is acquired, it is determined whether merging to the main line is possible on the basis of the acquired traffic condition information and the merging road length ε, and when it is determined that the merging to the main line is possible, by automatically controlling at least acceleration and deceleration of the host vehicle M such that the host vehicle M is traveling from the branch line to the main line, it is possible to rapidly perform a determination of whether the merging is possible.

As a result, for example, when it is determined that the merging is not possible, an operation right of the host vehicle can be quickly delegated to a driver.

### Second Embodiment

Hereinafter, a second embodiment will be described. The second embodiment is distinguished from the first embodiment in that, in the correspondence information 188 previously stored in the storage 180, the map configured to derive the traveling distance RD(k) corresponds to the vehicle-to-vehicle gap time δ(k) only. Hereinafter, this difference will be mainly described.

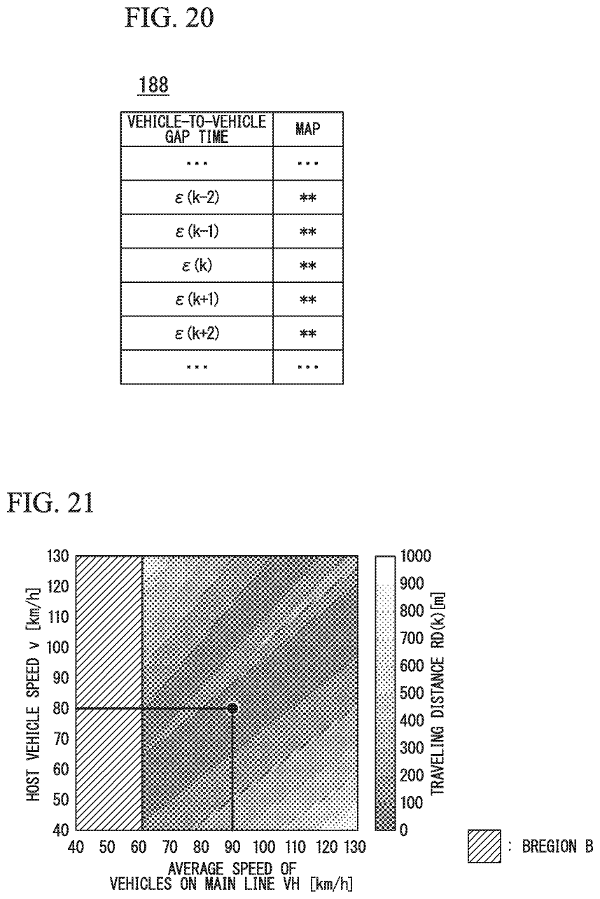

FIG. 20 is a figure showing an example of the correspondence information 188 according to the second embodiment. As shown in FIG. 20, in the correspondence information 188, the map corresponds to the vehicle-to-vehicle gap time δ(k).

FIG. 21 is a figure showing an example of a certain map in the correspondence information 188 of the second embodiment. A horizontal axis in FIG. 21 represents the average speed VH of the vehicles on the main line, a vertical axis represents the speed v of the host vehicle M when the host vehicle is traveling on a section to be merged, and a color bar on the right side of the map represents the traveling distance RD(k) using a color and a numerical value (0 to 1000 m in FIG. 21).

In the correspondence information 188, the derivation part 152 according to the second embodiment selects a map corresponding to the vehicle-to-vehicle gap time δ(k) having a value that coincides with or is closest to the vehicle-to-vehicle gap time δ(k) included in the traffic condition information acquired by the communication device 75, and derives the traveling distance RD(k) by using this map.

For example, in the example in FIG. 21, when the average speed VH of the vehicles of the main line is 90 km/h and the traveling speed v of the host vehicle M is set to 80 km/h, the traveling distance RD(k) is derived as approximately 100 m.

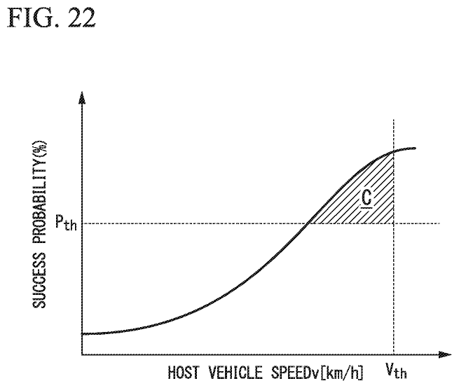

The speed v of the host vehicle M set in the map is determined by referring to, for example, the information shown in FIG. 22.

FIG. 22 is a figure showing an example of a relation between the success probability of the merging and the speed v of the host vehicle M. As shown in FIG. 22, the success probability of the merging varies in a tendency that becomes higher as the speed v of the host vehicle M is increased. Threshold values Pₜₕ and Vₜₕ are set to the success probability of the merging and the speed v of the host vehicle M. The threshold value Pₜₕ is set to, for example, about 100%, and the threshold value Vₜₕ is set to an upper limit speed such as a legal speed limit or the like.

For example, the derivation part 152 determines the traveling distance RD(k) by interpreting a speed within a range (a region C in FIG. 22) in which the speed v of the host vehicle M is the threshold value Vₜₕ or less and the success probability is the threshold value Pₜₕ or more, as the speed v of the host vehicle M.

The determination part 153 according to the second embodiment determines whether the host vehicle M can join the main line by comparing the traveling distance RD(k) derived using the map with the merging road length ε derived using the high accuracy map information 182 by the derivation part 152.

For example, the determination part 153 determines that the host vehicle M cannot join the main line when the traveling distance RD(k) is longer than the merging road length ε, and determines that the host vehicle M can join the main line when the traveling distance RD(k) is shorter than the merging road length ε.

According to the vehicle control system 100 A of the above-mentioned second embodiment, like the above-mentioned first embodiment, determination of whether the merging is possible can be rapidly performed. As a result, for example, when it is determined that the merging is impossible, an operation right of the host vehicle can be quickly delegated to a driver.

Hereinabove, although the aspects for implementing the present invention have been described using the embodiments, the present invention is not limited to the above-mentioned embodiments and various modifications and substitutions may be made without departing from the scope of the present invention.

### REFERENCE SIGNS LIST

20 Finder

30 Radar

40 Camera

50 Navigation device

60 Vehicle sensor

62 Display

64 Speaker

70 Operation device

72 Operation detecting sensor

75 Communication device

80 Selector switch

90 Driving force output apparatus

92 Steering apparatus

94 Brake apparatus

100 Vehicle control system

110 Target lane determining part

120 Automated driving controller

122 Host vehicle position recognition part

124 Outside recognition part

126 Action plan generating part

130 Trajectory generating part

132 Traveling state determining unit

134 Trajectory candidate generating part

136 Evaluation/selection part

140 Lane change controller

150 Merging controller

151 Merging target area candidate setting part

152 Derivation part

153 Determination part

160 Traveling controller

170 Switching controller

180 Storage

M Host vehicle

What is claim is:

1.-10. (canceled)

11. A vehicle control system comprising:
an acquisition unit that acquires traffic condition information of a main line to which a host vehicle is going to join from a branch line;
a first controller that derives success probability of merging from the branch line to the main line on the basis of the traffic condition information acquired by the acquisition unit and a length of a mergeable section in a merging place from the branch line to the main line and that determines whether the host vehicle is able to join the main line on the basis of the derived success probability; and
a second controller that automatically controls at least acceleration and deceleration of the host vehicle such that the host vehicle is traveling from the branch line toward the main line in a case it is determined by the first controller that the host vehicle is able to join the main line.

12. The vehicle control system according to claim 11, wherein, by referring to a correspondence information in which both of the information obtained from the traffic condition information and the length of the mergeable section are made to respectively correspond with a success probability of merging from the branch line to the main line, the first controller derives the success probability corresponding to the traffic condition information acquired by the acquisition unit, and determines whether the host vehicle is able to join the main line on the basis of the derived success probability.

13. The vehicle control system according to claim 11, wherein, in the correspondence information, a speed of the host vehicle is further made to correspond with the success probability, and
by obtaining the speed of the host vehicle and by referring to the correspondence information by using the acquired speed of the host vehicle, the first controller derives the success probability and determines whether the host vehicle is able to join the main line on the basis of the derived success probability.

14. The vehicle control system according to claim 11, further comprising a switching controller that restricts a control of the second controller in a merging in a case it is determined by the first controller that the host vehicle is not able to join the main line.

15. The vehicle control system according to claim 11, wherein the traffic condition information comprises an average speed of traveling vehicles on the main line and information from which an inter-vehicle distance of the traveling vehicles is able to be derived.

16. A vehicle control system comprising:
an acquisition unit that acquires traffic condition information of a main line to which a host vehicle is going to join from a branch line;
a derivation part that derives a traveling distance corresponding to the traffic condition information acquired by the acquisition unit by referring to correspondence information in which information obtained from the traffic condition information and information of a traveling distance, which relates to a distance in which the vehicle travels in order to join to the main line, correspond to each other; and
a controller that derives a success probability of merging onto the main line of the host vehicle on the basis of the traveling distance corresponding to the traffic condition information and a length of a mergeable section in a merging place from the branch line to the main line and that determines whether merging onto the main line is possible on the basis of the derived success probability.

17. The vehicle control system according to claim 16, wherein the success probability of the merging is a probability on the basis of a ratio between the length of the mergeable section and a traveling distance which the host vehicle travels from the branch line to the main line.

18. A method installed on a computer configured to control a vehicle, the method comprising:
acquiring traffic condition information of a main line to which a host vehicle is going to join from a branch line;
deriving a success probability of merging from the branch line to the main line on the basis of the acquired traffic condition information and a length of a mergeable section in which the host vehicle is able to join the main line from the branch line and determining whether the host vehicle is able to join the main line on the basis of the derived success probability; and
automatically controlling at least acceleration and deceleration of the host vehicle such that the host vehicle travels from the branch line toward the main line in a case it is determined that the host vehicle is able to join the main line.

19. A vehicle control program installed in an in-vehicle computer and configured to perform:
acquiring traffic condition information of a main line to which a host vehicle is going to join from a branch line;
deriving a success probability of merging from the branch line to the main line on the basis of the acquired traffic condition information and a length of a mergeable section in which the host vehicle is able to join the main line from the branch line and determining whether the host vehicle is able to join the main line on the basis of the derived success probability; and
automatically controlling at least acceleration and deceleration of the host vehicle such that the host vehicle travels from the branch line toward the main line in a case it is determined that the host vehicle is able to join the main line.
